(19) United States
(12) Patent Application Publication
(10) Pub. No.: US 2015/0032491 A1
(43) Pub. Date: Jan. 29, 2015

(54) COMPUTER PROGRAM, METHOD, AND SYSTEM FOR PREPARING AND PROCESSING AN ELECTRONIC WORK ORDER

(71) Applicant: UBIS, LLC, Athens, GA (US)

(72) Inventors: William L. Ulm, SR., Bogart, GA (US); James Kelley, Vero Beach, FL (US)

(21) Appl. No.: 14/445,881

(22) Filed: Jul. 29, 2014

Related U.S. Application Data
(60) Provisional application No. 61/859,593, filed on Jul. 29, 2013.

(51) Int. Cl. G06Q 10/06; G06Q 10/10

(52) U.S. Cl. CPC G06Q 10/06311; G06Q 10/10
USPC 705/7.13

(57) ABSTRACT

A computer program, method, and system for preparing and processing electronic work orders that receives transaction requirements and organizes them into an electronic work order. The electronic work order is in a customer-specific template. The current location and status of drivers is monitored. A driver is either selected or recommended based upon analysis of the electronic work order, the driver location and status, and a database of worksite information. The selected driver is contacted and sent to complete the transaction. The driver, via a driver device, is presented with information about the customer, the worksite and the route. The driver device assists the driver in performing electronic work order and recording the performance.

### RELATED APPLICATIONS

This application claims priority benefit, with respect to all common subject matter, of U.S. Provisional Patent Application No. 61/859,593, filed Jul. 29, 2013, and entitled “COMPUTER PROGRAM, METHOD, AND SYSTEM FOR PREPARING AND PROCESSING ELECTRONIC TICKETS” (the '593 Provisional Application). The disclosure of the '593 Provisional Application is hereby incorporated herein by reference in its entirety.

### BACKGROUND

1. Field

Embodiments of the invention are broadly directed to electronic work orders. More particularly, embodiments of the invention are directed to a computer program, method, and system of preparing and processing electronic work orders.

2. Related Art

Work orders are orders or requests received or obtained by an organization from a customer. Typically, work orders are indicative of a single or a few transactions that the customer would like to enter into with the organization. A work order is typically written on paper by hand. Many work orders are in a format specific to the customer and not specific to the organization performing the work order. Although an individual may quickly reference the information on the paper ticket, the information is not readily searchable, analyzable, or otherwise manipulatable. Further, work orders only contain information specific to the transaction and do not always contain other necessary information, such as worksite locations and storage unit sizes.

A dispatcher typically processes work orders by reading the information written thereon and deciding which, if any, agent can fulfill the requirements. The dispatcher then contacts the designated agent and either reads the relevant information or provides them with a written copy of the work order. This process is slow and prone to human error. Also, the driver will often require information about the customer, such as the size of the storage unit, that does not appear on the work order but is constant for that customer.

### SUMMARY

Embodiments of the invention solve the above-mentioned problems by providing a computer program, method, and system for preparing and processing electronic work orders. The electronic work order is organized according to a template that emulates existing work orders used by a customer. A database contains information about the worksites and storage units associated with the customer. A user inputs information indicative of a business transaction that is readily searchable by the computer program.

A first embodiment of the invention is directed to a non-transitory computer readable storage medium having a computer program stored thereon for preparing and processing the electronic work order. The computer program instructs at least one processing element to receive a customer information set; create a customer-specific work order template; receive a worksite information set having information indicative of a plurality of work sites and storage units; receive at least one transaction requirement and prompt the user for additional information; organize the information into the electronic work order and display it for approval; monitor the location and status of a set of drivers; identify at least one driver to perform the transaction requirements; instruct the driver to perform at least one transaction requirement; and provide the driver with the worksite information.

A second embodiment of is directed to a computerized method for preparing and processing of electronic work orders. The above-mentioned steps are performed via a processing element.

A third embodiment of the invention is directed to a system for preparing and processing electronic work orders. The system comprises a sales device for preparing the electronic work order and a driver device for performing the electronic work order. Embodiments of the system further comprise a dispatching device for processing and analyzing the electronic work order. Other embodiments of the system comprise a database for receiving, storing, analyzing and communicating the worksite information set.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 is a flow diagram of an exemplary embodiment of the invention, illustrating setup, work order preparation, work order processing, and work order performance;

FIG. 2 is a system diagram of an embodiment of the invention depicting various components of the system;

FIG. 3 is a flow diagram illustrating the interactions of a salesperson, a customer, a dispatcher, and a driver;

FIG. 4 is a flow diagram illustrating how, in the exemplary oil production industry, the driver performs the work order;

FIG. 5 is an environmental view of a work site in the exemplary oil production industry;

FIG. 6 is a screen capture depicting a graphical user interface of an embodiment of the invention displaying a home screen;

FIG. 7 is a screen capture depicting the graphical user interface of an embodiment of the invention displaying an upper portion of an input screen;

FIG. 8 is a screen capture depicting the graphical user interface of an embodiment of the invention displaying a lower portion of an input screen;

FIG. 9 is a screen capture depicting the graphical user interface of an embodiment of the invention displaying a transmission pending screen overlaid on the home screen;

FIG. 10 is a screen capture depicting the graphical user interface of an embodiment of the invention displaying a password screen to verify the authenticity of the user;

FIG. 11A is a first section of a screen capture of an exemplary electronic work order format;

FIG. 11B is a second section and continuation of the screen capture of FIG. 11A; and

FIG. 12 is a screen capture of another exemplary electronic work order format.

The drawing figures do not limit embodiments of the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

The invention provides various embodiments of a computer program, a method, and a system for preparing and processing an electronic work order 10 to facilitate a business transaction 12 between an organization 14, such as a transportation company 16, and a customer 18. The electronic work order 10 is an electronic document that may be printed or remain in electronic form. The electronic work order 10 comprises a customer information set 20 and at least one transaction requirement 22. Both of these are discussed in more detail below.

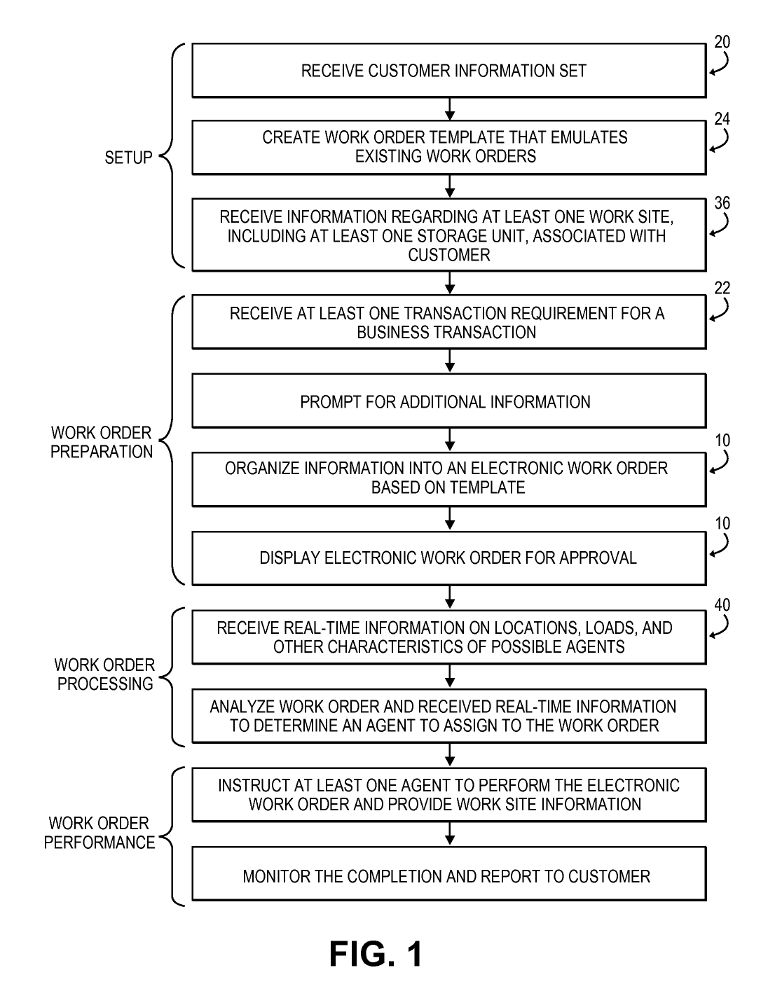

An exemplary embodiment of the invention is illustrated in FIG. 1. The electronic work order 10 is prepared by creating a work order template 24 specific to the customer 18, such as by emulating an existing format utilized by the customer 18. The template 24 may also bear a logo of the customer 18. A user 26, such as a salesperson 28, enters information into a set of electronic fields 30 of the electronic work order 10. The computer program may prompt the user 26 to enter additional information. Once complete, the computer program may present the electronic work order 10 for approval by the salesperson 28 or by the customer 18.

The work order 10 is processed by analyzing the work order 10 to determine how to efficiently and effectively complete the transaction requirements 22. In one embodiment, the analysis is performed in part by the computer program and in part by a dispatcher 32. The computer program accesses a worksite information set 34 indicative of worksites 36 and storage units 38 associated with the worksites 36. The computer program then analyzes a current status of a set of agents 40, such as drivers 42, who could fulfill the requirements. The dispatcher 32 then selects one of the plurality of drivers 42 based upon the computer program's analysis and notifies the driver 42 of the work order 10. In another embodiment, the analysis is performed solely by the dispatcher 32. In still another embodiment, the analysis is performed solely by the computer program.

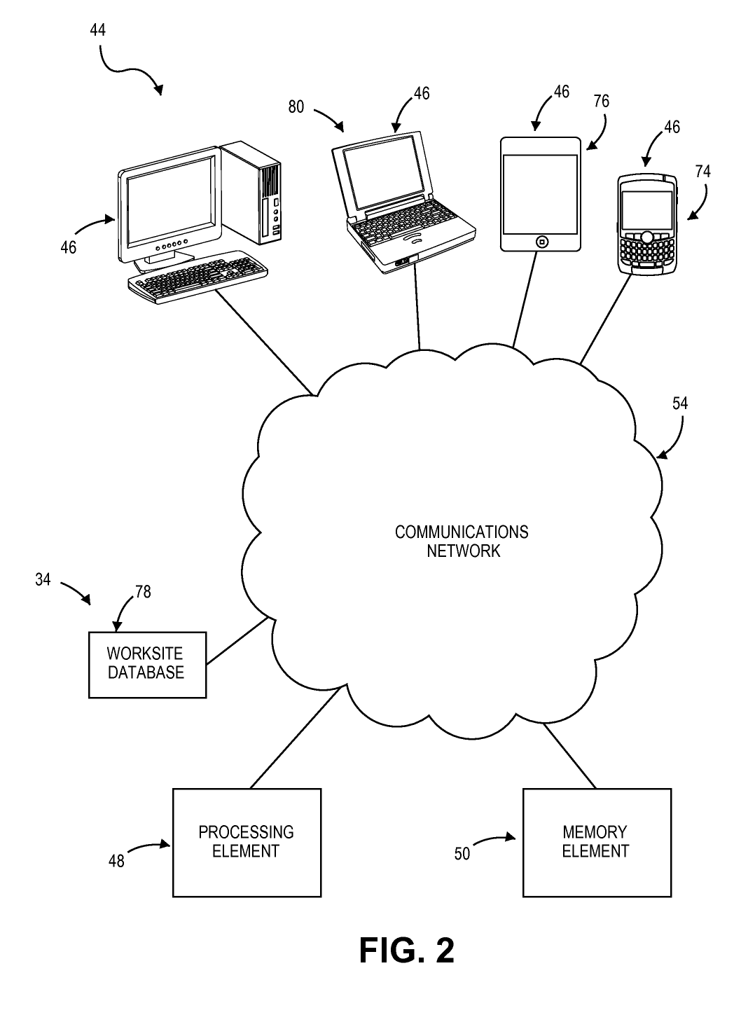

Turning to FIG. 2, a system 44 of embodiments of the invention may comprise at least one computing device 46 to facilitate the functions and features described herein. The computing devices 46 may comprise any number and combination of processors, controllers, integrated circuits, programmable logic devices, or other data and signal processing devices for carrying out the functions described herein, and may additionally comprise one or more memory storage devices, transmitters, receivers, and/or communication busses for communicating with the various devices of the system 44.

The computer program of embodiments of the invention comprises a plurality of code segments executable by the computing device 46 for performing the steps of various methods of the invention. The steps of the method may be performed in the order discussed, or they may be performed in a different order, unless otherwise expressly stated. Furthermore, some steps may be performed concurrently as opposed to sequentially. Also, some steps may be optional. The computer program may also execute additional steps not described herein. The computer program, system 44, and method of embodiments of the invention may be implemented in hardware, software, firmware, or combinations thereof.

The computer program of embodiments of the invention may be responsive to user input. As defined herein user input may be received from a variety of computing devices 46 including but not limited to the following: desktops, laptops, calculators, telephones, smartphones, or tablets. The computing devices 46 may receive user input from a variety of sources including but not limited to the following: keyboards, keypads, mice, trackpads, trackballs, pen-input devices, printers, scanners, facsimile, touchscreens, network transmissions, verbal/vocal commands, gestures, button presses or the like.

The computing devices 46 may include any device, component, or equipment with at least one processing element 48 and at least one associated memory element 50. The processing element 48 may implement operating systems, and may be capable of executing the computer program, which is also generally known as instructions, commands, software code, executables, applications (“apps”), and the like. The processing element 48 may include processors, microprocessors, microcontrollers, field programmable gate arrays, and the like, or combinations thereof. The memory element 50 may be capable of storing or retaining the computer program and may also store data, typically binary data, including text, databases, graphics, audio, video, combinations thereof, and the like. The memory element 50 may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), and the like, or combinations thereof. In addition to the memory element 50, a server device may further include file stores comprising a plurality of hard disk drives, network attached storage, or a separate storage network.

The computing devices 46 may specifically include mobile communication devices (including wireless devices), work stations, desktop computers, laptop computers, palmtop computers, tablet computers, portable digital assistants (PDA), smart phones, and the like, or combinations thereof. Various embodiments of the computing device 46 may also include voice communication devices, such as cell phones and/or smart phones. In preferred embodiments, the computing device 46 will have an electronic display operable to display visual graphics, images, text, etc. In certain embodiments, the computer program facilitates interaction and communication through a graphical user interface (GUI) 52 that is displayed via the electronic display. The GUI 52 enables the user 26 to interact with the electronic display by touching or pointing at display areas to provide information to the system 44.

A communications network 54 may be wired or wireless and may include servers, routers, switches, wireless receivers and transmitters, and the like, as well as electrically conductive cables or optical cables. The communications network 54 may also include local, metro, or wide area networks, as well as the Internet, or other cloud networks. Furthermore, the communications network 54 may include cellular or mobile phone networks, as well as landline phone networks, public switched telephone networks, fiber optic networks, or the like.

The computer program may run on computing devices 46 or, alternatively, may run on one or more server devices. In certain embodiments of the invention, the computer program may be embodied in a stand-alone computer program (i.e., an “app”) downloaded on a user's computing device 46 or in a web-accessible program that is accessible by the user's computing device 46 via the communications network 54. As used herein, the stand-along computer program or web-accessible program provides the user 26 with access to an electronic resource from which the user 26 can interact with various embodiments of the invention.

In embodiments of the invention, users 26 may be provided with different types of accounts. Each type of user account may provide their respective users 26 with unique roles, capabilities, and permissions with respect to implementing embodiments of the invention. For instance, the salesperson 28 may be provided with a salesperson account that permits the salesperson 28 to access embodiments of the invention that are applicable to the salesperson 28 entering transaction requirements 22, creating electronic work orders 10, editing the customer-specific template 24, and managing customer business transactions 12. Additionally, the customer 18 may be provided with a customer account that permits access to embodiments of the invention that are applicable to managing business transactions 12, completing electronic work orders 10, and communicating with the assigned driver 42. Additionally, the dispatcher 32 may be provided with a dispatcher account that permits the dispatcher 32 to monitor the drivers 42, receive and analyze electronic work orders 10, assign work requirements to the drivers 42, access and send information indicative of the worksite 36 and the storage unit 38, and monitor the completion of transaction requirements 22. Additionally, the driver 42 may be provided with a driver account that permits the driver 42 to access embodiments of the invention that are applicable to receiving electronic work orders 10, obtaining information indicative of the worksite 36 and the storage unit 38, and reporting the progress of transaction requirements 22. In addition, any number and/or any specific types of account are provided to carry out the functions, features, and/or implementations of the invention. Upon the salesperson 28, customer 18, dispatcher 32, or driver 42 logging into the electronic resource for a first time, the respective entity may be required to provide various items of identification information to create their respective accounts. Such identification information may include, for instance, personal name, business name, email address, phone number, or the like. Upon providing the identification information, the respective user may be required to enter (or may be given) a username and a password, which will be required to access the electronic resource.

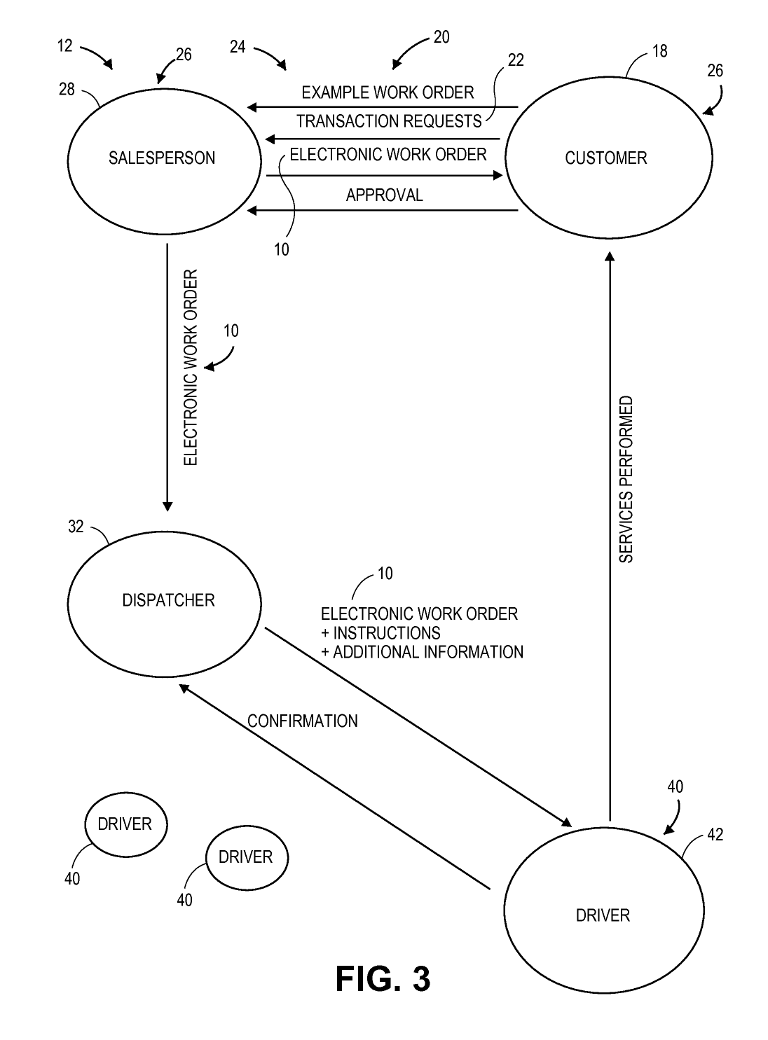

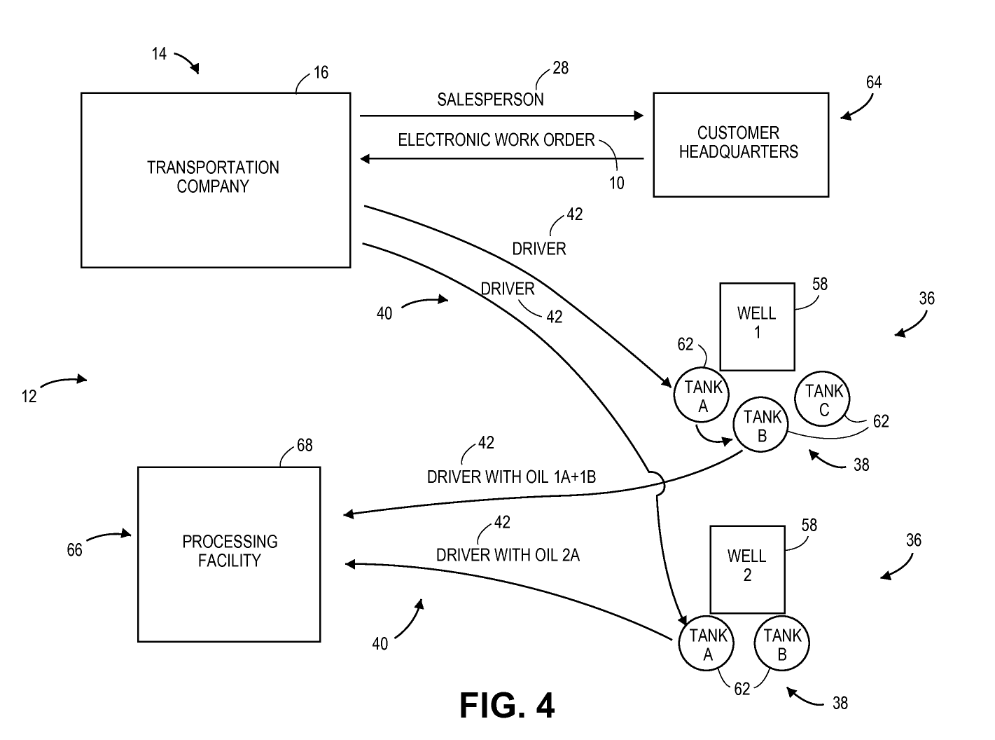

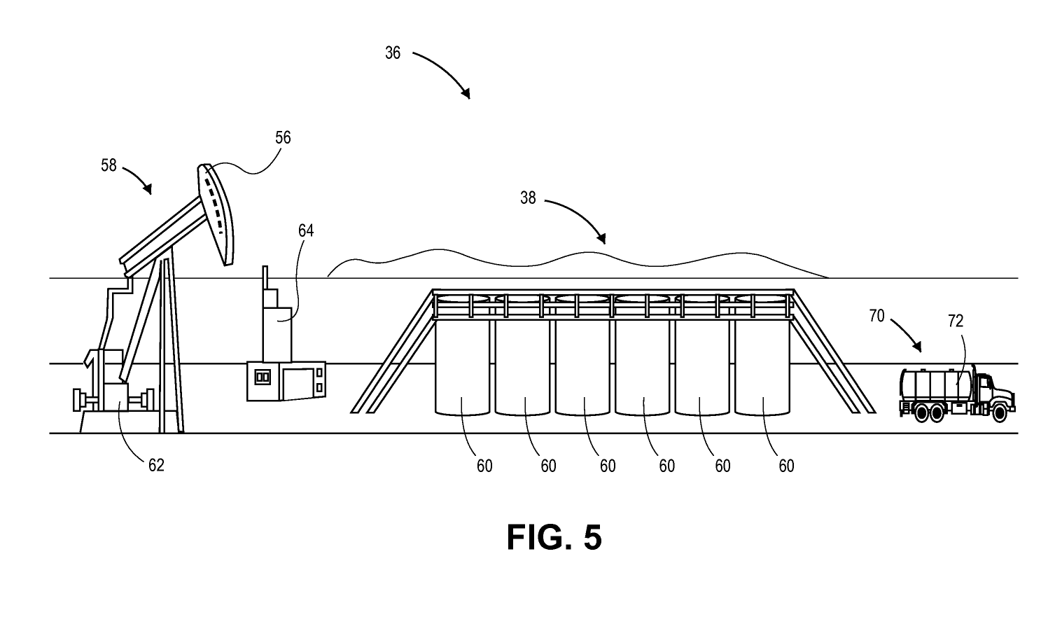

It should be noted that the oil and gas industry is used in this application as an exemplary application, as illustrated in FIGS. 3-4. The following description deals with the extraction of petroleum oil hydrocarbons or natural gas via a derrick 56 of an oil well 58 and an electrical generator 60. The oil or natural gas is then stored at the worksite 36, discussed below, in a tank 62 near the oil well 58 until it can be transported. Customer agents in or associated with a headquarters building 64 then arrange or contract with the transportation company 16 to move the oil to a processing facility 66, such as an oil refinery 68. However, it should be understood that the computer program, method, and system may be used in any type of profession or business, such as construction, shipping, mining, agriculture, medicine, financial services, and retail.

In the exemplary context of the oil industry, the electronic work order 10 may include instructions to move a certain amount of oil from the tank 62 to the processing facility 66. Many oil wells 58 are located in remote locations, far from pipelines and highways. Often transportation companies perform the task of moving the oil from the tank 62 near the oil well 58. The work order 10 contains information about the customer 18, who is associated with the oil well 58, and a specific tank or tanks 62 from which the customer 18 would like to remove oil. The work order 10 may set forth a schedule of pick-ups, but due to the variable rate of production and delays due to maintenance, the schedule is not set.

In the exemplary context of the oil industry, the organization 14 responsible for fulfilling the work order 10 may be the transportation company 16. The transportation company 16 owns or controls at least one vehicle 70, such as a tank truck 72, and has an associated driver 42 for that vehicle 70. The vehicle 70 is adapted to store and transport oil from the tank 62 to the processing facility 66 or other location, such as an oil pipeline. The customer 18 is associated with the oil well 58. The customer 18 can be associated with the oil well 58 by owning the oil well 58, leasing the oil well 58, subletting the oil well 58, operating the oil well 58, providing the labor to run the oil well 58, owning or leasing the land under the oil well 58, owning or controlling a company operates the oil well 58, or some combination thereof.

As illustrated in FIGS. 3-4, the customer 18 contracts with the transportation company 16 to move all or a portion of the oil produced at certain wells or stored in certain tanks 62. The contract may be a separate written contract into which the customer 18 and transportation company 16 enter into which lays out the key terms and conditions. The work orders 10 are made in furtherance of the contract and lay out specific business transactions 12. The customer 18 will often work with more than one transportation company 16. Similarly, the transportation company 16 will often work with more than one customer 18. The customer 18 will often have a single work order format that they utilize among all transportation companies, and for other business-related transactions, such as maintenance.

In other embodiments, the transportation company 16 and the customer 18 are each within a single legal entity. Because they are a single entity, there may be no contract between the customer 18 and the organization 14; however, work orders 10 may still be used to denote specific transportation requirements.

The setup, as illustrated in FIG. 1, will now be discussed. In embodiments of the invention, the computer program receives the customer information set 20 indicative of the customer 18. This customer information set 20 comprises various information such as a customer name, the customer logo, a customer mailing address, a customer phone number, and a customer e-mail address. The set of information may also include information about the customer 18, such as the location and size of oil wells 58 associated with the customer 18, the size and location of storage units 38 associated with the customer 18, the location of petroleum processing facilities 66 associated with the customer 18, and the location of pipelines associated with the customer 18. The customer information set 20 is stored in the database 34, which may also contain similar information for other customers. In some embodiments, the database 34 contains information for all oil wells 58 and storage units 38 within a certain geographic region.

The salesperson 28, within the exemplary oil production context, is an employee or other agent of the transportation company 16 that facilitates the transportation of oil from the tanks 62 near oil wells 58 to the processing facility 66. The salesperson, on behalf of the transportation company 16, enters into contracts with the customer 18 or issues electronic work orders 10 in furtherance of existing contracts.

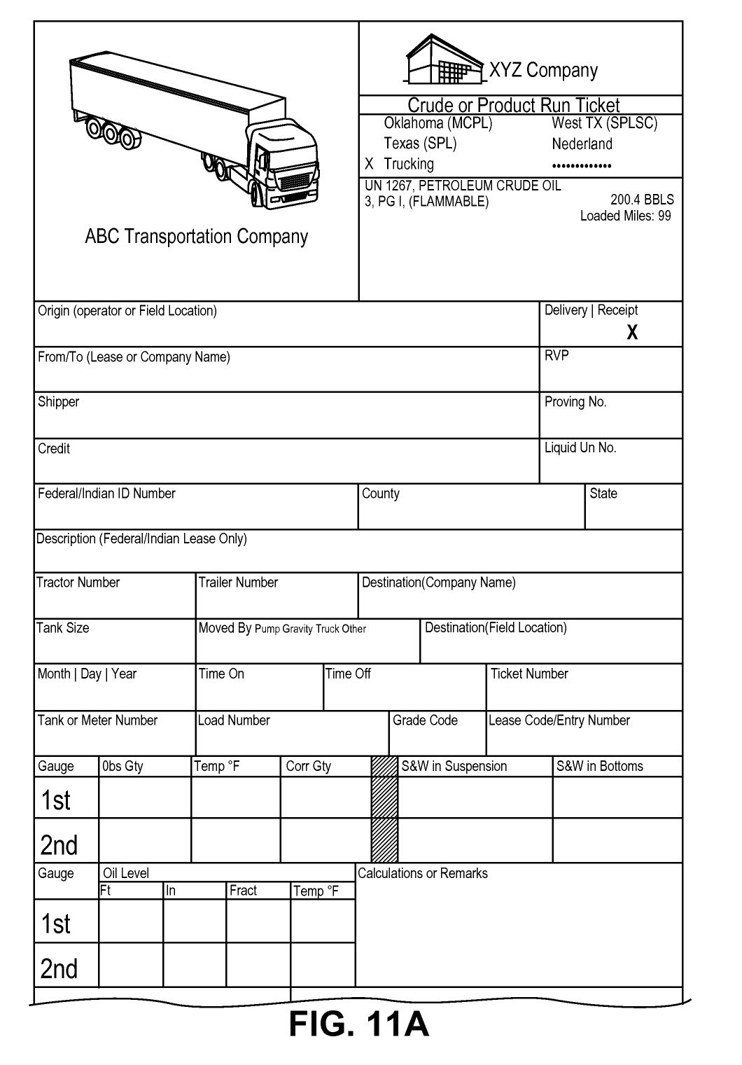

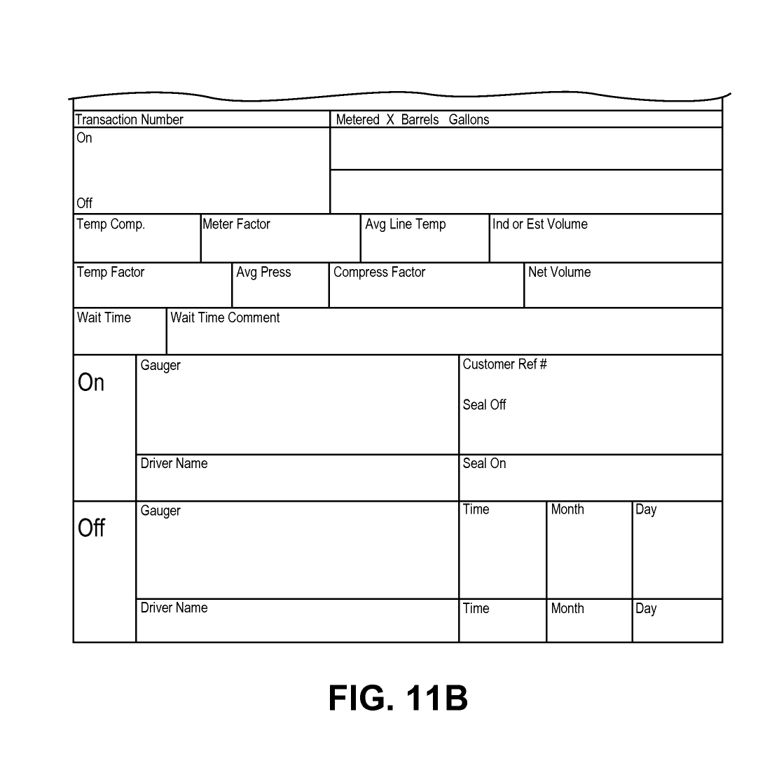

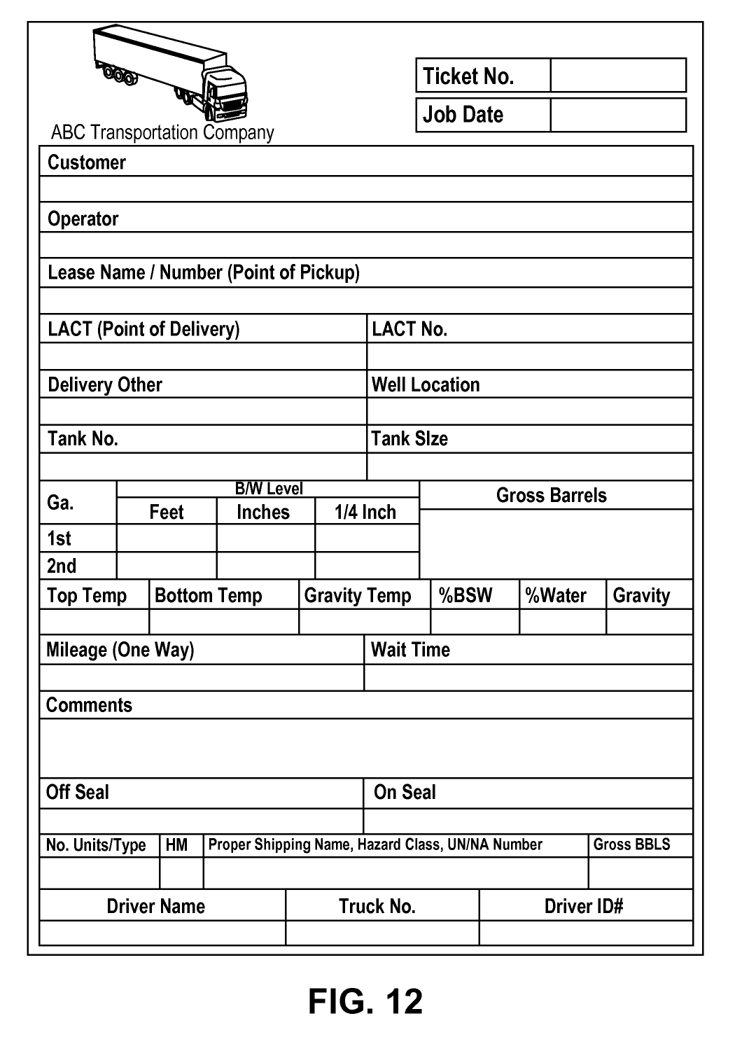

The salesperson 28 or other person associated with the transportation company 16 creates the work order template 24. Example work order templates are illustrated in FIGS. 11A, 11B, and 12. The work order template 24 is customized to the customer 18 and emulates existing work order formats already used by the customer 18. The salesperson 28 or other person receives a copy of an existing work order and then emulates the layout on the work order template 24. The work order template 24 may include the customer logo. It may also include customer information, such as customer name, address, and billing information. Emulating the work order template 24 to match existing work order formats used by the customer 18 is advantageous because it will be easier for the customer 18 to transition to the electronic work order 10. Because many customers utilize a plurality of transportation companies, some of whom use paper work orders or other formats, customers typically want all their work orders to look the same or similar.

In one embodiment, the emulation of existing work order formats is performed by a method comprising: acquiring a paper copy of a work order used by the customer 18, creating a hyper text markup language (HTML) file that creates text boxes and fields 30 as they appear on the paper work order, making the text boxes electronically fillable such that a person can type into it, and making the information in the text box computer-searchable. In another embodiment, the computer program receives a scanned copy of the paper ticket or information indicative of the paper ticket. The computer program then reads the information written on the paper ticket including the layout of textboxes. The computer program then arranges a standard electronic work order to closely emulate the input paper ticket and adds the information as read from the paper ticket to create a draft work order template. The computer program then presents the draft work order template to the user 26 along with options to change the draft work order template. After receiving any alterations to the draft work order template, the computer program saves the work order template 24 to be later utilized.

The computer program also accesses the worksite information set 34. This information is static or semi-static information that will be utilized by the dispatcher 32 and/or the driver 42 fulfilling the requirements. In the exemplary context of oil production, the database 34 will include information such as the location and size of oil wells 58, the location and dimensions of tanks 62, safety and route information for the wells, and the location of the customer headquarters. This database 34 may be created and maintained by the transportation company 16, a governmental body, or an industrial organization 14. The database 34 may include information for multiple customers and may include the information for all wells in a geographic area or the entire world. Because the transportation company 16 may work with a limited number of customers out of all the customers in a geographic area, the computer program may filter the information to include only those worksites 36 that are associated with customers of the transportation company 16.

The worksite 36 of the exemplary oil field comprises many components, such as the oil well 58, the electrical generator 60, the headquarters building 64, and the storage unit 38 comprising at least one tank 62. The tank 62 temporarily stores the oil that is produced by the oil well 58 with the assistance of the electrical generator 60. The tank 62 is a large container adapted to receive and store oil. The tank 62 has a capacity associated with it. Typically, the oil production industry uses “barrels,” equivalent to 119.24 liters or 31.5 gallons, as the unit to describe the capacity, though other units of volume could be used. The shape of the tank 62 can be cylindrical, rectangular prism, square prism, spherical, semi-spherical, or other shape. All or some of the tank 62 may be below ground level. The database 34, discussed above, may include any or all of this information about the tanks 62.

The operation of the computer program during transactions will now be discussed. The typical transaction in the oil production industry is an agreement that the driver 42 will travel to the tank 62, fill the vehicle 70 with a certain amount of oil, and transport the oil to the oil refinery. The transaction requirements 22, as discussed herein, are information indicative of this agreement. Portions of the transaction requirement 22 may include amount of oil, oil well name, tank name, tank size, worksite location, timeline, payment information, refinery location, and special equipment or training requirements. In one embodiment, the salesperson 28 inputs the transaction requirements 22 into the computer program after or while talking with the customer 18. In another embodiment, the customer 18 enters the information into the computer program themselves.

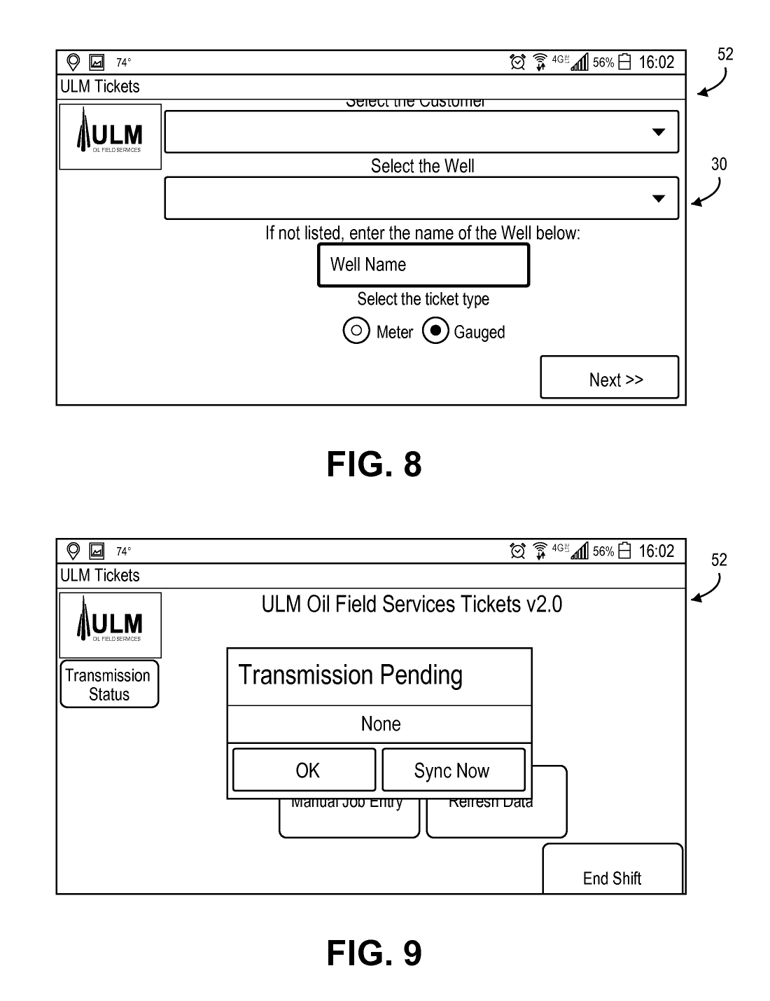

The user 26 (e.g. the salesperson 28 or the customer 18) inputs data into the computer program via the GUI 52 on a display. In one embodiment, the GUI 52 presents a depiction of the work order template 24 and invites user 26 to fill in the electronic fields 30 with information, as illustrated in FIGS. 11A-12. In another embodiment, the GUI 52 presents a standard input field 30, as illustrated in FIG. 7-8.

As the user 26 inputs information, the computer program, via the GUI 52, prompts the user 26 for additional information based upon the information provided. The computer program intelligently reacts to the inputted information by assisting the user 26 in completing the form. For example, upon the selection of the oil well 58 from a list, the GUI 52 may present a list of the tanks 62 present at the worksite 36 associated with that oil well 58 and prompt the user 26 to select one or more of those tanks 62. The computer program may also automatically fill in the fields 30 with certain information, such as the current date.

The information that is input is formatted to be readily processed by other copies of the computer program and/or by unrelated processing programs. For example, a work order number may be a combination of the salesperson's initials, the current date in yy/mm/dd form, followed by the number of work orders previously written that day plus one (e.g., JD1306273 for John Doe's third sale on Jun. 27, 2013). In this way, the input may be easily searched, ordered, compared, and cataloged based on any of the data that make up the input. For example, work orders created by John Doe may be found by searching for work orders that begin with “JD”.

The computer program organizes the information into the electronic work order 10, based upon the work order template 24. The electronic work order 10 therefore visually appears substantially similar to the paper work orders that the customer 18 already uses. The computer program marks or tags certain information contained in the electronic work order 10 so that the electronic work order 10 can be search, organized, and analyzed. For example, the computer program could search for all electronic work orders 10 initiated on a certain date, or all electronic work orders 10 associated with a specific oil well 58. This allows the dispatcher 32 and a manager to efficiently run operations. This also allows the computer program to utilize and manipulate the inputted information in other ways. For example, the computer program could remove non-essential portions, such as the billing address, when presenting the electronic work order 10 to the driver 42.

The computer program then presents the electronic work order 10 for approval. The computer program may also present the electronic work order 10 for approval to parties other than the user 26 that created the electronic work order 10. The computer program may receive a digital signature, a username and password for approval, a pin for approval, or a button click for approval.

Some customers prefer to have a printed copy of the electronic work order 10 for their use. Other customers prefer to use the electronic work order 10. Therefore, the computer program presents an option to print the electronic work order 10 to the user 26 and other parties. Even if the customer 18 uses a printed copy of the electronic work order 10, the transportation company 16 can still access the electronic work order 10 and manipulate data as needed.

The processing of the electronic work order 10 will now be discussed. In order to efficiently perform the electronic work order 10, either or both of the computer program and the dispatcher 32 will analyze the electronic work order 10 and the available drivers 42 to perform the work order 10.

The computer program monitors a location and a status of a plurality of drivers 42 that are each an agent of the transportation company 16. The location is monitored via a GPS or other location and navigation element associated with the vehicle 70. The location is communicated to the computer program via a communication element associated with a driver device 74 within the vehicle 70.

The computer program provides the electronic work order 10 to the dispatcher 32. The computer program may log the electronic work order 10 into a database comprising other work orders, or it may send the electronic work order 10 directly to the dispatcher 32. In one embodiment, the computer program displays the electronic work order 10 on a dispatcher device automatically after the electronic work order 10 is approved by the user 26. In another embodiment, the computer program provides the electronic work order 10 to the dispatcher 32 via an electronic mail. In yet another embodiment, the user 26 sends the electronic work order 10 as an attachment to an electronic mail. In still a further embodiment, the user 26 notifies the dispatcher 32 that an electronic work order 10 has been completed, and the dispatcher 32 pulls the electronic work order 10 from the computer program.

The dispatcher 32 then processes the electronic work order 10, by using a copy of the computer program. The computer program displays for the dispatcher 32 the electronic work order 10 along with information indicative of the available drivers 42. It may include a recommended driver 42 for the dispatcher 32 to select. The computer program may select and recommend a specific driver 42 by comparing work start and stop dates and times against other electronic work orders 10 currently logged in the database 34. The computer program may assign drivers 42 and equipment to a job based on delivery locations, work times, pay schedules, and other considerations. In this way, work logistics are optimized, which reduces the cost of operation by eliminating unnecessary expenditures and minimizing time spent on tasks.

In other embodiments, the computer program acts, at least in part, like the dispatcher 32. In one embodiment, the computer program selects and sends the electronic work order 10 to the driver 42 without dispatcher 32 oversight. In another embodiment, the computer program selects the driver 42 and presents the selection to the dispatcher 32 for approval. In selecting the specific driver 42, the computer program may schedule drivers 42 based on time constraints and priorities of the work to be done, locations of the cargo and the drivers 42, and types of cargo and trucks. For example, the computer program may select the first available driver 42 off of a “rotating list” and assign him to the electronic work order 10 with the earliest start time. The computer program may check if the driver 42 has worked more than a maximum allowed number of hours (e.g., 40 hours), has not been “off the clock” for a minimum required number of hours (e.g., 8 hours) or is on vacation, in which case the computer program will select the next available driver 42. The computer program may also compare cargo locations with driver locations to find the driver 42 closest to the cargo. For example, if the electronic work order 10 requires a shipment to be picked up at point A and delivered to point B, the computer program may search for drivers 42 who drive the A-B route (and thus, are familiar with the route) and are currently located at or near point A. This reduces wait times, reduces fuel costs and vehicle wear, and reduces the number of drivers 42 transported to other locations as passengers. Lastly, if the cargo is hazardous, the computer program may search for hazardous material certified drivers.

The performance of the electronic work order 10, as illustrated in FIG. 1, will now be discussed. The agent 40, such as the driver 42, completes the performance of the electronic work order 10. The driver 42 is an agent, employee, or independent contractor of the transportation company 16. In the exemplary oil production context, the driver 42 drives the tank truck 72, also known as a tanker truck or a tanker. The tank truck 72 is a motor vehicle 70 adapted to carrying a liquefied load. The driver 42 performs the electronic work order 10 by fulfilling the at least one transaction requirement 22, as discussed above. This can include driving from his location to the worksite 36, filling his tank truck 72 with the stated amount of oil from the specified tank 62, and transporting the oil to the refinery. However, other transaction requirements 22 would also be within the scope of the invention.

The driver device 74 is located in or associated with the tank truck 72. In one embodiment the driver device 74 is a cellular smart phone running an application. In another embodiment, the driver device 74 is a computing device mounted or located in the cab of the truck 72 and running a version of the computer program. The driver device 74 allows the driver 42 to input information about himself or the tank truck 72, as discussed above.

The computer program, via the driver device 74, also receives and displays information from the various other components of the system 44. For example, the driver device 74 may receive or calculate a route the driver 42 should drive to move from the driver's current location to the worksite 36, and from the worksite 36 to the oil refinery 68. The driver device 74 may also display a map and populate the map with icons illustrating, for example, the driver's current location, the location of other drivers, the location of various worksites 36 as recorded in the worksite information set 34, the location of the tank 62 within the worksite 36, and the location of the oil refinery 68. The computer program may also only display the worksites 36 that are relevant to the driver 42, such as the worksites 36 associated with customers 18 of the transportation company 16. The computer program may also access and display the dimensions of the tank 62 associated with the electronic work order 10.

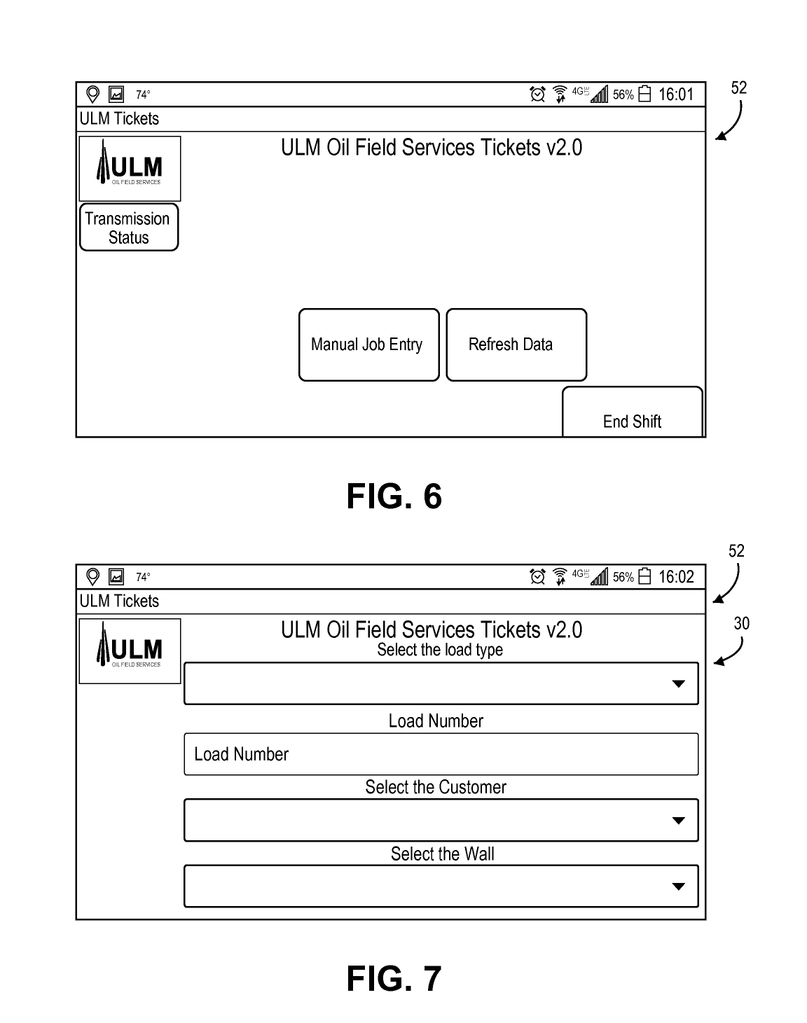

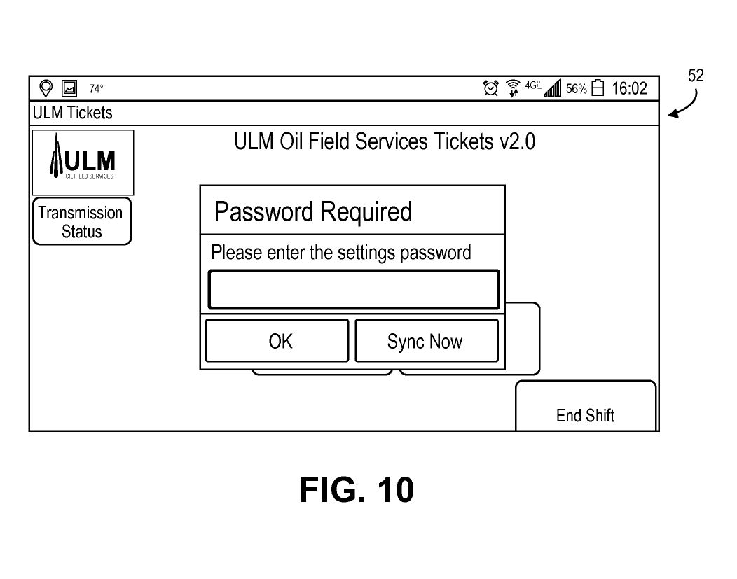

The driver device 74 also allows the driver 42 to manually input a work order 10, as illustrated in FIGS. 7-8, such as in the event the driver 42 receives a paper work order. This allows the system to continue to monitor the activities of the driver 42. Similarly, as shown in FIG. 6, the driver device 74, via the GUI 52, displays a home screen, which allows the driver 42 to select a desired operation for the computer program. As shown in FIG. 9, the driver device 74 receives transmissions from the other devices indicative of the electronic work order 10 to be performed. If the driver 42 is outside an area with communication and returns to the area, he can select the exemplary “transmission status” button on FIG. 6 to display the screen shown in FIG. 9. The screen of FIG. 9 informs the driver 42 that there is currently no current transmission in progress, but allows the driver 42 to sync, i.e. check for pending transmission. Certain functions, such as illustrated in FIG. 10, may require the driver 42 to input the assigned password, as discussed above.

In some embodiments of the invention, the driver device 74 assists the driver 42 in completing the electronic work order 10 by automatically filling in fields. For example, the computer program may monitor the distance traveled by the vehicle 70 to the worksite 36 and then to the oil refinery 68. The computer program then records this information automatically in the appropriate field the electronic work order 10. The driver device 74 may also communicate the distance traveled to the other computing devices 46 of the system 44 via the communication network 54. Similarly, for example, the computer program may interface or read the gauge or thermometer at the tank, so that the driver 42 does not have to manually enter the figures into the computer program. Similarly, for example, the computer program may automatically calculate the gross barrels based upon the input first gauge reading and second gauge reading, as shown in FIG. 12.

Upon the completion of performance of the electronic work order 10, the driver 42 submits the completed electronic work order 10. In embodiments of the invention, the computer program may receive a digital signature from the driver 42, such as the driver signing a touchpad, entering a password, or entering biometric data. In other embodiments, the driver 42 does not sign the completed electronic work order 10. The driver device 74 then sends the completed electronic work order 10 to the various other computing devices 46 of the system 44 via the communication network 54. The other computing devices 46 may further analyze or amend the completed electronic work order 10.

In embodiments of the invention, when the driver 42 indicates that he has completed his shift, by selecting the “end shift” button as shown in FIG. 6, the computer program may generate a report (not illustrated) that displays information such as hours worked, miles driven, barrels moved, electronic work orders completed, etc. The computer program of the driver device 74 may send this report to the various other computing devices 46 of the system 44 via the communication network 54.

Particular components of the system are now discussed. The system 44 comprises a plurality of computing devices 46, as discussed above and illustrated in FIG. 2. In one embodiment, the system 44 comprises a sales device 76 and the driver device 74. The sales device 76 is a computing device 46 comprising a sales display and a sales non-transitory computer readable storage medium having the computer program stored thereon. The sales device 76 receives the customer information set 20 and the at least one transaction requirements 22, which are input by either the salesperson 28 or the customer 18. The driver device 74, as discussed above, is a computing device 46 comprising a driver display and a driver non-transitory storage medium having the computer program stored thereon. The driver device 74 monitors the location, via a location element such as a GPS, and status of the vehicle 70 and driver 42. The driver device 74 also receives and displays information indicative of the electronic work order 10 and at least a portion of the worksite information set.

In some embodiments of the invention, the system further comprises a worksite database 78. The worksite database 78 comprises a database non-transitory computer readable storage medium having the computer program stored thereon. The worksite database 78 receives, stores, processes, and organizes the worksite information set 34, as discussed above. The worksite database 78 also communicates with the other devices to provide at least a portion of the worksite information set upon request. The worksite database 78 may also automatically send to the driver 42, and displays on the driver device 74, at least a portion of the electronic work order 10 and the worksite information set 34.

In some embodiments of the invention, the system further comprises a dispatching device 80. The dispatching device 80 is a computing device comprising a dispatching display and a dispatching non-transitory computer readable storage medium having the computer program stored thereon. As discussed above, the dispatching device 80 analyzes the electronic work order 10, the worksite information set, and a set of drivers 42. In one embodiment, the dispatching device 80 selects the driver 42 and sends the information to the driver 42 automatically. In another embodiment, the dispatching device 80 selects the driver 42 and presents an option for the dispatcher 32 to accept the recommended driver 42. In still another embodiment, the dispatching device 80 displays a plurality of possible drivers 42 who could complete the transaction requirements 22 in a prioritized list, and invites the dispatcher 32 to select at least one.

Each of the above-mentioned computing devices 46, hereinafter referred to as a user device, displays an interface to a user 26 for entering information pertaining to a particular job, sale, shipment, or task. The interface includes input fields 30 and other visual aids, discussed below, for the user 26 to enter information. The user device may include a memory for the computer program to store the information. Alternatively, the user device may be communicatively connected to another device or remote server for storing the information. The user device may also be communicatively connected to another user device (e.g., the first user device may be used to generate the electronic work order 10, the second user device may be used process the electronic work order 10, and a third user device may be used to perform the electronic work order 10) and to a printer for printing paper copies of the work order 10 or ticket.

The user device may be any form of computing device such as a desktop computer, laptop, tablet, smartphone, television, and automobile on-board computer. The user device includes a user input, such as a button or buttons, keyboard, keypad, mouse, remote control, video game controller, microphone, accelerometer, or touch screen. The user device includes circuitry and/or computer code for transmitting signals, requests, commands, or other data to remote devices over a network for submitting information. The circuitry may include a modem, router, antenna, wireless transmitter, or other components for connecting to a network. The user device may also be configured to receive signals, requests, commands, or other data from the network. The user device may include a memory for temporarily storing user inputted data or “cookies”, which signify that the data has been previously provided.

The GUI 52 provides a plurality of inputs such as text boxes, radio buttons, checkboxes, drop down menus, signature fields, and other inputs for inputting information into the electronic work order 10. The GUI 52 may also include visuals such as windows, prompts, alerts, error messages, on-screen instructions, menus, spreadsheets, file management displays, media players, and other programs, applications, or systems for assisting in collecting data and information and guiding and instructing the user 26. The GUI 52 may intelligently change or display the various visuals described above based on the user inputs. For example, as the salesperson 28 creates the electronic work order 10 and begins to enter an input such as a business name, if the computer program recognizes the beginning of the business name, the interface may suggest the full business name or “autofill” the input field 30 with the business name. As another example, if the driver 42 inputs nonsensical data such as an “8” for a tank temperature reading that should only range between 60 and 100 degrees, the interface may display an error message stating that the temperature reading is likely incorrect and should be re-inputted. As yet another example, if the driver 42 inputs a temperature reading above a threshold temperature, the interface may display a dialogue instructing the driver 42 to perform additional tasks such as manipulating a valve on the tank 62. As a still further example, if the user inputs a “total time” spent on a task that is greater than a maximum amount of time charged at a base pay rate, thereby invoking overtime pay, the interface may prompt the user 26 to enter the overtime pay rate for the amount of time in excess of the maximum amount of time charged at the base pay rate.

The layout of the electronic work order 10 and the work order template 24 will now be discussed. FIGS. 11A, 11B, and 12 provide exemplary formats and exemplary fields 30 for which information should be entered via the GUI 52 of the computer program. FIG. 11A bears the customer logo, and a transportation company logo. As discussed above, the work order template 24 as shown in FIGS. 11A-11B is customized and specific to the customer 18 and includes not only the customer logo but also contains the set of fields 30 as the customer desires and laid out in a format to emulate the existing work orders used by the customer. In other embodiments, as illustrated in the FIG. 12, the work order template 24 bears only the transportation company logo.

It should be noted that multiple parties complete the portions of the electronic work orders 10, as illustrated in FIGS. 11A, 11B, and 12. The salesperson 28 or customer 18, for example, may fill in the upper portion of the electronic work order 10, such as the “Origin,” “From/To,” “Shipper,” etc. The dispatcher 32, for example, may fill in the center portion of the electronic work order 10, such as the “Tractor Number,” “Trailer Number,” “Ticket Number,” “Driver Name,” etc. The driver 42, for example, may fill out the bottom portion of the electronic work order 10, such as the gauge readings, temperature readings, “Wait time,” and the time and date of completion.

The computer program also fills in portions of the electronic work order 10, by retrieving information from the customer information set 20 and the worksite information set 34. Once a particular field has been completed, the computer program searches for other information that may be relevant to the electronic work order 10 and fills in the information. For example, when the salesperson 28 enters the customer name, the computer program may automatically fill in the customer address and customer logo. Similarly, for example, when the salesperson 28 enters the tank number, the computer program may automatically fill the tank size associated with that tank number. Similarly, for example, when the dispatcher 32 selects the driver 42 to complete the electronic work order 10, the computer program may automatically fill in the mileage by retrieving the driver's location and calculating a route from the driver to the worksite. The computer program may also display this route to the driver 42 on the driver device 74.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A non-transitory computer readable storage medium having a computer program stored thereon for preparing and processing an electronic work order, wherein the computer program instructs at least one processing element to perform the following steps:
receiving, from a user computing device, a customer information set indicative of a customer;
creating a work order template specific to the customer comprising at least a portion of the customer information set,
wherein the work order template is formatted to emulate a paper work order used by the customer;
receiving a worksite information set indicative of a plurality of worksites,
wherein each of the plurality of worksites comprises at least one storage unit,
wherein said worksite information set comprises a descriptor for each storage unit, wherein the descriptor comprises a location and a size for each storage unit,
wherein the customer is associated with at least one storage unit;
receiving, from the user computing device, at least one transaction requirement indicative of a business transaction;
prompting the user, via a graphical user interface, to enter at least one additional transaction requirement based upon the work order template and at least a portion of the at least one transaction requirement received from the user;
organizing the at least one transaction requirement into said electronic work order,
wherein the electronic work order is in said work order template;
displaying the electronic work order, via the graphical user interface, to the user for approval;
monitoring a location and a status of a set of drivers;
identifying at least one driver within the set of drivers to fulfill the at least one transaction requirement;
instructing the at least one driver to perform the at least one transaction requirement; and
providing, to the at least one driver, at least a portion of the worksite information set indicative of the worksite and the storage unit associated with the customer and with the at least one transaction requirement.

2. The non-transitory computer readable storage medium of claim 1, further comprising the step of sending at least a portion of said worksite information set to the driver.

3. The non-transitory computer readable storage medium of claim 1, further comprising the step of storing the worksite information set in a worksite database such that the driver can access at least a portion of the worksite information set in furtherance of completing the at least one transaction requirement.

4. The non-transitory computer readable storage medium of claim 1, wherein the identifying the at least one driver is performed by the steps comprising:
analyzing the electronic work order, the worksite information set, and the set of drivers;
selecting a plurality of drivers from the set of drivers that could complete the at least one transaction requirement;
organizing the plurality of drivers into a prioritized list of drivers;
presenting, on a dispatcher device, the prioritized list of drivers to a dispatcher along with an option to select at least one driver within the prioritized list of drivers; and
receiving a selection from the dispatcher of at least one driver to complete the at least one transaction requirement.

5. The non-transitory computer readable storage medium of claim 1, wherein the identifying the at least one driver is performed by the steps comprising:
analyzing the electronic work order, the worksite information set, and the set of drivers; and
selecting at least one driver from the set of drivers to complete the at least one transaction requirement.

6. The non-transitory computer readable storage medium of claim 5, wherein the identifying the at least one driver is performed by the steps further comprising:
presenting, to a dispatcher and on a dispatcher device, the selected at least one driver; and
presenting, to the dispatcher and on the dispatcher device, an option for the dispatcher to confirm the selected at least one driver.

7. A computerized method for preparing and processing an electronic work order, wherein the method comprises the following steps:
receiving, via a processor, a customer information set indicative of a customer;
creating, via a processor, a work order template specific to the customer comprising the customer information set,
wherein the work order template is formatted to emulate work orders used by the customer;
receiving, via a processor, a worksite information set indicative of a plurality of worksites,
wherein each of the plurality of worksites comprises at least one storage unit,
wherein said set of information comprises a descriptor for each storage unit, comprising a location and a size,
wherein the customer is associated with at least one storage unit;
receiving, via a processor, from the user computing device, at least one transaction requirement indicative of a business transaction;
prompting the user, via a processor and via a graphical user interface, to enter at least one additional transaction requirement based upon the work order template and at least a portion of the plurality of transaction requirements received from the user;
organizing the at least one transaction requirement into an electronic work order,
wherein the electronic work order is in said work order template;
displaying, via a processor and the graphical user interface, the electronic work order to the user for approval;
monitoring, via a processor, a location and a status of a set of drivers;
identifying at least one driver within the set of drivers to fulfill the at least one transaction requirement;
instructing, via a processor, the at least one driver to perform the at least one transaction requirement; and
providing, via a processor to the at least one driver, information indicative of the worksite and the storage unit associated with the customer and with the at least one transaction requirement.

8. The method of claim 7, further comprising the step of sending, via a processor, at least a portion of said worksite information set to the driver.

9. The method of claim 7, further comprising the step of storing, via a processor, the worksite information set in a database such that the driver can access at least a portion of the worksite information set in furtherance of completing the at least one transaction requirement.

10. The method of claim 7, wherein the identifying the at least one driver is performed by the steps comprising:
analyzing, via a processor, the electronic work order, the worksite information set, and the set of drivers;
selecting, via a processor, a plurality of drivers from the set of drivers that could complete the at least one transaction requirement;
organizing, via a processor, the plurality of drivers into a prioritized list of drivers;
presenting, via a processor, the prioritized list of drivers to a dispatcher along with an option to select at least one driver within the prioritized list of drivers; and
receiving a selection from the dispatcher of at least one driver to complete the at least one transaction requirement.

11. The method of claim 7, wherein the identifying the at least one driver is performed by the steps comprising:
analyzing, via a processor, the electronic work order, the worksite information set, and the set of drivers; and
selecting, via a processor, at least one driver from the set of drivers to complete the at least one transaction requirement.

12. The method of claim 11, wherein the identifying the at least one driver is performed by the steps further comprising:
presenting, via a processor to a dispatcher and on a dispatcher device, the selected at least one driver; and
presenting, via a processor to the dispatcher and on the dispatcher device, an option for the dispatcher to confirm the selected at least one driver.

13. A system for preparing and processing an electronic work order, the system comprising:
a sales device comprising a sales display and a sales non-transitory computer readable storage medium having a sales computer program stored thereon for generating the electronic work order, wherein the sales computer program instructs at least one processing element to perform the following steps:
receiving a customer information set indicative of a customer;
receiving at least one transaction requirement indicative of a business transaction;
organizing the customer information set and the at least one transaction requirement into said electronic work order,
wherein the electronic work order is formatted based upon a work order template specific to the customer;
a driver device comprising a driver display and a driver non-transitory computer readable storage medium having a driver computer program stored thereon for instructing a driver to perform the electronic work order, wherein the driver computer program instructs at least one processing element to perform the following steps:
receiving a location of the driver device from a location element;
instructing the driver to perform said at least one transaction requirement;
retrieving a worksite information set indicative of a worksite associated with the customer and associated with the electronic work order;
presenting the worksite information set and at least a portion of the electronic work order.

14. The system of claim 13, further comprising a worksite database comprising a database non-transitory computer readable storage medium having a database computer program stored thereon on for receiving and retaining information indicative of a plurality of worksites, wherein at least a portion of the plurality of worksites is associated with the customer.

15. The system of claim 13, further comprising a dispatching device comprising a dispatching display and a dispatching non-transitory computer readable storage medium having a dispatching computer program stored thereon for processing the electronic work order, wherein the computer program instructs at least one processing element to perform the following steps:
analyzing the electronic work order, the worksite information set, and a set of drivers;
selecting a plurality of drivers that could complete the at least one transaction requirement from the set of drivers;
organizing the plurality of drivers into a prioritized list of drivers;
presenting the prioritized list of drivers to a dispatcher along with an option to select at least one driver within the prioritized list of drivers; and
receiving, from the dispatcher, a selection of at least one driver to complete the at least one transaction requirement.

16. The system of claim 13, further comprising a dispatching device comprising a dispatching display and a dispatching non-transitory computer readable storage medium having a dispatching computer program stored thereon for processing the electronic work order, wherein the computer program instructs at least one processing element to perform the following steps:
analyzing the electronic work order, the worksite information set, and a set of drivers; and
selecting at least one driver from the set of drivers to complete the at least one transaction requirement.

17. The system of claim 10, wherein the dispatching computer program on the dispatching device instructs the at least one processing element
presenting, to a dispatcher, the selected at least one driver; and
presenting, to the dispatcher, an option for the dispatcher to confirm the selected at least one driver.
